(19) United States
(12) Patent Application Publication
(10) Pub. No.: US 2005/0081899 A1
(43) Pub. Date: Apr. 21, 2005

(54) Adjustable spacer attachment for a power washer

(76) Inventor: Michael Shannon, Levittown, NY (US)

Correspondence Address: Daniel P. Burke;GALGANO & BURKE, Suite 135, 300 Rabro Drive, Hauppauge, NY, 11754, US

(21) Appl. No.: 10/688,764

(22) Filed: Oct. 16, 2003

(51) Int. Cl. B08B 3/02

(52) U.S. Cl. 134/172; 134/174; 134/198; 239/172; 239/754

(57) ABSTRACT

The disclosed embodiments of the present invention find an attachment for use with a power washer which maintains a constant distance between the washer nozzle and the surface being cleaned. The attachments of the present invention are advantageously readily attachable and detachable from a standard power washer, allow adjustability of the space between the washer nozzle and the surface being cleaned, and are relatively simple and inexpensive to manufacture.

The present invention relates to power washers, and more particularly, to a power washer with an adjustable spacer attachment.

### BACKGROUND

Various forms of cleaning and spraying devices have been previously disclosed. Such devices have directed streams of fluids, e.g. water, are to a surface to be cleaned. These devices tend to be relatively bulky and are unsuitable for use with a common power washer. For example, U.S. Pat. No. 3,931,931 to Otis discloses a surface washer. The surface washer has a horizontal pipe member fitted with spaced nozzles. Rotatably attached at each end is a support movable comprising casters. At least three casters are employed to obtain a horizontally stable support. A handle is attached to and communicates interiorly with the pipe member at one of its ends, the other end being fitted with a water hose connection. Preferably each caster is pivoted on a shaft in a common bearing, and which has a head rotatable in a closed socket.

U.S. Pat. No. 4,022,382 to Engdahl, Jr. discloses a surface cleaning device. A high pressure wall of water is directed at a surface to be cleaned from a plastic discharge tube having multiple nozzles. The discharge tube is joined at right angles to a plastic inlet tube. The inlet tube connects to a garden hose through a valve and coupling arrangement. The discharge tube has two caster-type wheels mounted approximately midway between the union of the discharge tube and inlet tube and the respective ends of the discharge tube.

U.S. Pat. No. 5,653,392 to Wells discloses a water spray apparatus. The water spray apparatus is designed for dual function use in washing motor vehicle undercarriages or in cleaning ground surfaces. The apparatus has a hollow cross tube axially supported by a pair of wheels and pivotally connected to a union. The cross tube has a row of commonly facing orifices for generating a row of commonly directed water streams. Directional reversal of the water streams is accomplished by pivotal rotation of the cross tube.

Although many various surface washing apparatus have been proposed throughout the years, one apparatus which is in widespread use today is the device known as the “power washer”. Prior art FIG. 1 illustrates a typical power washer. The power washer 10 includes a long wand 12 having an adjustable nozzle 14 at one end and a handle 16 at the other end. The handle 16 has a trigger valve 18 and is coupled to a hose 20 which supplies high pressure water from a pump 22. The pump 22 may be either gas powered or electric.

A frequent application for the state of the art power washer is the cleaning of flat surfaces such as wooden decks and cement or brick patios. The intensity of the cleaning power of the power washer is partially determined by the nozzle adjustment and partially determined by the distance between the nozzle and the surface being cleaned. Thus, in order to obtain an even finish on the surface being cleaned, it is desirable to maintain a relatively constant distance between the surface and the nozzle. This can be difficult with the state of the art power washers.

The problem of maintaining a constant distance between washing nozzles and the surface being cleaned is not addressed by the devices shown in the above referenced U.S. Patents. These devices are relatively complex and are not intended to work with a common powerwasher. In addition, none of these devices is readily adjustable with regard to the space between the nozzles and the surface to be cleaned.

### SUMMARY OF THE INVENTION

One embodiment of the present invention comprises a spacing rod having a wheel or caster at one end and a movable connector. The connector is movable along at least part of the length of the spacing rod and is removably attachable to the wand of a power washer. According to the preferred illustrated embodiment, the spacing rod is provided with a plurality of evenly spaced detents or holes which are engageable by a spring biased pin positioned on the connector. The other end of the connector is provided with one or more c-clamps for engaging the power washer wand.

The spacing rod can be, for example, about three feet long and the connector can be, for example, about eight inches long by about four inches tall. The entire attachment is easily connected and disconnected to a power washer wand using the set screws of the c-clamps. The illustrated embodiment facilitates quick, accurate adjustment of the space between the wand nozzle and the surface to be cleaned by snapping the extension's spring biased pin from one detent to another. The attachment may be made of metal, plastic, a combination of metal and plastic, and/or other suitable materials.

The disclosed embodiments of the present invention find an attachment for use with a power washer which maintains a constant distance between the washer nozzle and the surface being cleaned. The attachments of the present invention are advantageously readily attachable and detachable from a standard power washer, allow adjustability of the space between the washer nozzle and the surface being cleaned, and are relatively simple and inexpensive to manufacture.

### BRIEF DESCRIPTION OF THE DRAWINGS

FIG. 1 is a perspective view of a prior art power washer; and

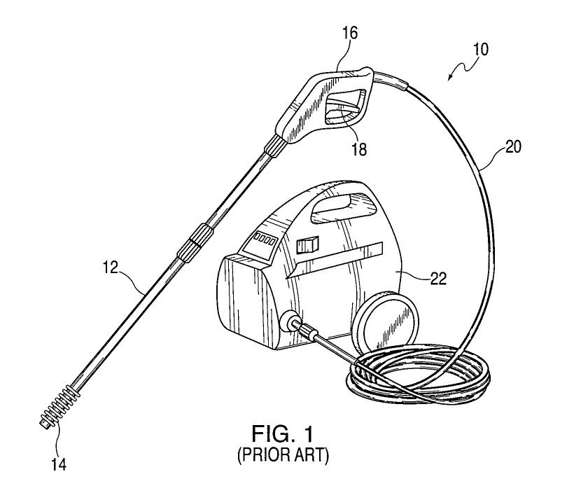

FIG. 2 is a side view of one embodiment of the present invention shown with a prior art power washer wand.

### DETAILED DESCRIPTION

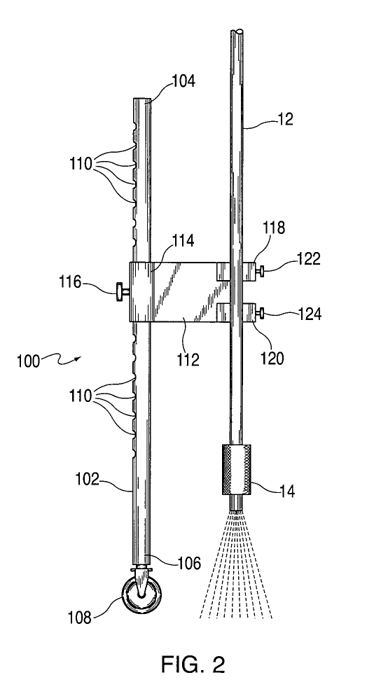

One preferred embodiment of the present invention illustrated in FIG. 2 comprises a spacer attachment 100 comprising a spacing rod 102 having a first end 104 and a second end 106. A rotatable support 108, e.g. a pivoting wheel, is mounted at one end 106 and a plurality of detents or holes 110 are provided along at least part of the length of the rod 102. According to one preferred embodiment, the rod 102 is approximately three feet long and one to two inches in diameter. The detents or holes are spaced one to two inches apart. The rod 102 may be made of metal such as aluminum or steel and/or of plastic such as PVC tubing. The caster 108 may be made of metal, plastic, or a combination of metal and plastic.

Spacer rod 102 can also be formed in longer lengths used for, for example, for cleaning the side of a building and can also be formed of a connectable segments. It is also within the scope of the present invention to provide unevenly spaced detents or holes 110.

The illustrated movable connector 112 has a sleeve 114 with a spring biased pin 116 at one end and a pair of c-clamps 118, 120 at the other end. The c-clamps 118, 120 each have a set screw 122, 124. The extension 112 can be of any suitable shape and/or dimensions. One illustrated embodiment is preferably about eight inches wide and about four inches tall. The diameter of the sleeve 114 is dimensioned to fit neatly about a portion of the rod 102 and the spring biased pin 116 is dimensioned to engage the detents or holes 110. The c-clamps 118, 120 are dimensioned to receive a power washer wand 12. The sleeve 114 and the c-clamps 118, 120 are preferably rotatably connected to the extension 112. The extension 112, pin 116 and the set screws 122, 124 may be formed of any suitable material or combination of materials including metal and plastic.

From the present description, those skilled in the art will appreciate that the adjusted attachment can be easily connected to a power washer wand 12 by manipulating the set screws 122, 124. Once the wand 12 is attached to the extension 112, the distance of the nozzle 14 from the surface to be washed may then be adjusted by moving the extension 112 up and down along the rod 102. In particular, pulling on the pin 116 will release the extension from the detent or hole 110 so that it may be moved to another detent. Releasing the pin 116 will allow it to engage another detent or hole 110 under the action of a spring (not shown). It will also be appreciated that the distance of the nozzle 14 from the surface to be washed may also be adjusted by loosening the set screws 122, 124 and sliding the wand 12 up or down, then retightening the set screws.

One preferred embodiment of the present invention comprises a power washing apparatus comprising a power washer comprising a hollow conduit and a nozzle; a spacer for use with said power washer comprising a spacer having a first end and a second end, a rotatable support connected to said second end of said spacer rod, a connector for connecting said spacer and said conduit, said connector comprising means for adjusting the relative positions of said nozzle and said rotatable support.

Another embodiment comprises a power washer and wand spacer combination, comprising a power washer comprising a wand, a nozzle and a pump coupled to said wand by a hose, a spacer having a first end and a second end, a rotatable support connected to said second end of said spacer, a connector extending from said wand to said spacer; said connector comprising a releasable clamp adapted to releasably connect to said power washer wand.

1. A power washing apparatus comprising:
a power washer comprising a hollow conduit and a nozzle;
a spacer for use with said power washer comprising;
a spacer having a first end and a second end;
a rotatable support connected to said second end of said spacer rod;
a connector for connecting said spacer and said conduit, said connector comprising means for adjusting the relative positions of said nozzle and said rotatable support.

2. A power washer apparatus according to claim 1, wherein said connector is selectively movable along at least a portion of said spacer between said first and second end.

3. A power washer according to claim 2 wherein said connector comprises has a spring biased pin and said spacer comprises a plurality of detents or holes between said first and second end which are engageable by said spring biased pin.

4. A power washer according to claim 3, wherein said adjusting means comprises at least one c-clamp.

5. A power washer according to claim 3, wherein said releasable clamp includes two spaced apart c-clamps.

6. A power washer according to claim 1, wherein said adjusting means comprises at least one c-clamp.

7. A power washer according to claim 2 wherein said adjusting means comprises at least two spaced apart c-clamps.

8. A power washer and wand spacer combination, comprising:
a power washer comprising a wand, a nozzle and a pump coupled to said wand by a hose;
a spacer having a first end and a second end;
a rotatable support connected to said second end of said spacer;
a connector extending from said wand to said spacer; said connector comprising
a releasable clamp adapted to releasably connect to said power washer wand.

9. A power washer apparatus according to claim 8, wherein said connector is selectively movable along at least a portion of said spacer between said first and second end.

10. A power washer according to claim 9 wherein said connector comprises has a spring biased pin and said spacer comprises a plurality of detents or holes between said first and second end which are engageable by said spring biased pin.

11. A power washer according to claim 8, wherein said adjusting means comprises at least one c-clamp.

12. A power washer according to claim 8, wherein said releasable clamp includes two spaced apart c-clamps.

13. A power washer according to claim 8, wherein said adjusting means comprises at least one c-clamp.

14. A power washer according to claim 8 wherein said adjusting means comprises at least two spaced apart c-clamps.
